(19) United States
(12) Patent Application Publication
(10) Pub. No.: US 2023/0302485 A1
(43) Pub. Date: Sep. 28, 2023

(54) Glue Scraping Mechanism, Wall Brick Laying Device and Wall Brick Laying Method

(71) Applicant: GUANGDONG BRIGHT DREAM ROBOTICS CO., LTD., Guangdong (CN)

(72) Inventor: Tao HE, Guangdong (CN)

(21) Appl. No.: 18/325,058

(22) Filed: May 29, 2023

Related U.S. Application Data
(63) Continuation of application No. PCT/CN2022/078268, filed on Feb. 28, 2022.

(30) Foreign Application Priority Data
Mar. 4, 2021 (CN) 202110240594.3

(51) Int. Cl. B05C 11/04; E04F 21/18

(52) U.S. Cl. CPC B05C 11/048; E04F 21/1838

(57) ABSTRACT

A glue scraper mechanism includes a first detection unit and a glue scraper assembly. The first detection unit is electrically connected to the glue scraper assembly. The first detection unit is configured to acquire protrusion and recess information of a wall. The glue scraping assembly is configured to be able to adjust a glue scraping thickness according to the protrusion and recess information.

### CROSS-REFERENCE TO RELATED APPLICATION(S)

This is a continuation of International Patent Application No. PCT/CN2022/078268, filed Feb. 28, 2022, which claims priority to Chinese Patent Application No. 202110240594.3 filed with the China National Intellectual Property Administration (CNIPA) on Mar. 04, 2021, the disclosure of which is incorporated herein by reference in its entirety.

### TECHNICAL FIELD

The present application relates to the field of architectural decoration and finishing technology, for example, a glue scraping mechanism, a wall tile paving device, and a wall tile paving method.

### BACKGROUND

A glue spreading apparatus of a wall tile paving robot has the main function of evenly spreading wall tile glue on wall tiles. When a wall is flat, it can meet the paving requirements. However, in practical work, the wall is not flat enough. If the thickness of wall tile glue is uniform, some wall tiles may be recessed or protruded. In order to guarantee the overall flatness of the paved wall tiles, a single wall tile may have a defect such as being hollow or being pasted insecurely.

### SUMMARY

Embodiments of the present application provide a glue scraping mechanism used for controlling a thickness of spread glue. The glue scraping mechanism includes a first detection unit and a glue scraping assembly. The first detection unit is electrically connected to the glue scraping assembly. The first detection unit is configured to acquire protrusion and recess information of a wall. The glue scraping assembly is configured to be able to adjust a glue scraping thickness according to the protrusion and recess information.

Embodiments of the present application further provide a wall tile paving device. The wall tile paving device includes a mechanical arm, a chassis, a tile laying assembly, and the glue scraping mechanism according to any preceding embodiment. The glue scraping mechanism, the tile laying assembly, and the mechanical arm are disposed on the chassis. A first detection unit is connected to the mechanical arm.

Embodiments of the present application further provide a wall tile paving method. The wall tile paving method includes extracting a point cloud of wall information, acquiring protrusion and recess information of a wall, converting the protrusion and recess information of the wall into glue thickness information, and spreading and scraping glue according to the glue thickness information.

### BRIEF DESCRIPTION OF DRAWINGS

To illustrate solutions in embodiments of the present application more clearly, the accompanying drawings used in description of the embodiments will be briefly described below. Apparently, the subsequent drawings illustrate part of embodiments of the present application, and those of ordinary skill in the art may obtain other accompanying drawings based on the accompanying drawings described below on the premise that no creative work is done.

FIG. 1 is a view illustrating the entire structure of a glue scraping mechanism (with a first bracket hidden) according to embodiments of the present application.

FIG. 2 is a view illustrating the entire structure of the glue scraping mechanism (with the first bracket hidden) from a first perspective according to embodiments of the present application.

FIG. 3 is a section view in a III - III position of FIG. 2.

FIG. 4 is a view illustrating the structure of the glue scraping mechanism (with the first bracket hidden) from a second perspective according to embodiments of the present application.

FIG. 5 is a section view in a V - V position of FIG. 4.

FIG. 6 is a view illustrating the entire structure of the glue scraping mechanism (with the first bracket displayed) according to embodiments of the present application.

FIG. 7 is an exploded view of the glue scraping mechanism (with the first bracket displayed) according to embodiments of the present application.

FIG. 8 is a view illustrating the structure of a wall tile paving device according to embodiments of the present application.

FIG. 9 is a view illustrating partial connection relationships of the first detection unit.

Reference list

| | |
|---|---|
| 10 | glue scraping mechanism |
| 20 | wall tile paving device |
| 100 | first detection unit |
| 101 | first controller |
| 200 | glue scraping assembly |
| 210 | drive member |
| 220 | scraper |
| 230 | chamfering plate |
| 240 | side glue scraping plate |
| 260 | glue blocking plate |
| 270 | connection plate |
| 280 | second detection unit |
| 300 | glue spreading assembly |
| 400 | second bracket |
| 500 | drive assembly |
| 600 | wall tile clamp |
| 610 | second motor |
| 620 | rotary shaft |
| 630 | clamping clip |
| 700 | first bracket |
| 810 | mechanical arm |
| 820 | chassis |
| 830 | tile laying assembly |

### DETAILED DESCRIPTION

Technical solutions in embodiments of the present application will be described in conjunction with drawings in embodiments of the present application. Apparently, the embodiments described herein are part, not all, of embodiments of the present application. Generally, the components of embodiments of the present application described and illustrated in the drawings herein may be arranged and designed through various configurations.

Therefore, the following detailed description of embodiments of the present application and shown in the drawings is not intended to limit the scope of the present application, but merely illustrates the selected embodiments of the present application. Based on the embodiments described herein, all other embodiments obtained by those skilled in the art without creative work are within the scope of the present application.

It is to be noted that similar reference numerals and letters indicate similar items in subsequent drawings. Therefore, once some item is defined in one drawing, the item needs no more definition and explanation in the subsequent drawings.

In the description of embodiments of the present application, it is to be noted that the orientational or positional relationships indicated by terms “center”, “above”, “below”, “left”, “right”, “vertical”, “horizontal”, “inside”, “outside” and the like are based on the orientational or positional relationships illustrated in the drawings, the orientational or positional relationship that products of the present disclosure are usually used in, or the orientational or positional relationship usually understood by those skilled in the art, which are for the mere purpose of facilitating and simplifying the description of the present application and do not indicate or imply that the device or component referred to has a specific orientation and is constructed and operated in a specific orientation, and thus it is not to be construed as limiting the present application.

Moreover, terms “first”, “second” and “third” are merely for distinguishing the description and are not to be construed as indicating or implying relative importance.

In the description of embodiments of the present application, it is to be noted that unless otherwise expressly specified and limited, the term “configured”. “installed”, “connected to each other” or “connected” should be construed in a broad sense as securely connected, detachably connected or integrally connected; mechanically connected or electrically connected; directly connected to each other or indirectly connected to each other via an intermediary; or intraconnected between two components. For those of ordinary skill in the art, specific meanings of the preceding terms in the present application may be construed according to specific circumstances.

### Embodiment

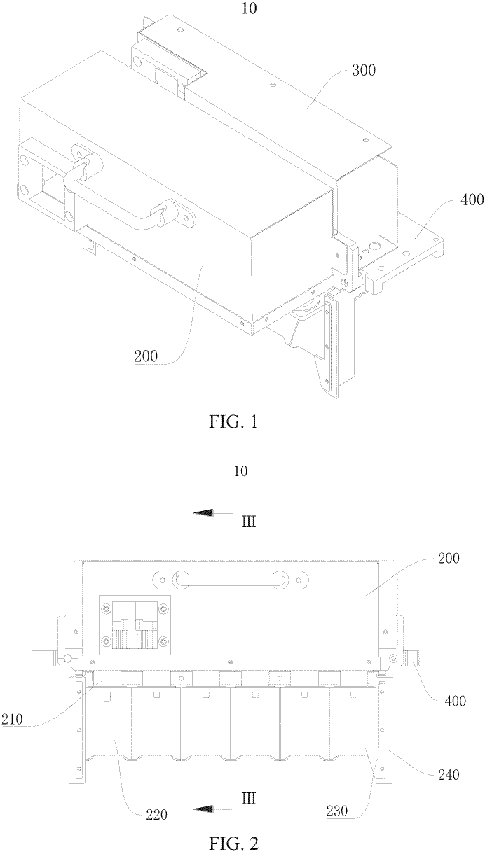

Referring to FIG. 1, this embodiment provides a glue scraping mechanism 10 controlling the thickness of spread glue. The glue scraping mechanism 10 includes a first detection unit 100 and a glue scraping assembly 200. The first detection unit 100 is electrically connected to the glue scraping assembly 200. The first detection unit 100 is configured to acquire the protrusion and recess information of a wall. The glue scraping assembly 200 is configured to be able to adjust glue scraping thickness according to the protrusion and recess information. The first detection unit 100 of the glue scraping mechanism 10 can acquire the protrusion and recess information of the wall and extract a point cloud of wall information. The glue scraping thickness of a wall tile can be adjusted according to the protrusion and recess information of the wall through the glue scraping assembly 200 so that glue is totally attached to the wall in the completion of paving, guaranteeing a pasting effect and achieving a relatively low hollowing rate. A part of connection relationships of the first detection unit 100 is shown in FIG. 9.

The glue scraping assembly 200 can adjust the glue scraping thickness according to the protrusion and recess information. For example, when a certain position on the wall is recessed by 1 mm, the glue scraping thickness of a position on the corresponding wall tile and corresponding to the position increases by 1 mm. When a certain position on the wall is protruded by 1 mm, the glue scraping thickness of a position on the corresponding wall tile and corresponding to the position decreases by 1 mm.

In this embodiment, the glue scraping assembly 200 includes a depth camera and a first controller 101. The depth camera is electrically connected to the first controller 101. The first controller 101 is electrically connected to the glue scraping assembly 200. The depth camera can shoot the wall and send data acquired through shooting to the first controller 101. The first controller 101 processes the data shot through the depth camera so as to acquire the protrusion and recess information. Additionally, according to the protrusion and recess information, the first controller 101 can control the glue scraping assembly 200 to scrape glue on the wall tile so that the glue scraping thickness matches the protrusion and recess situation of the wall. For example, when a position on the wall is recessed, correspondingly, the glue scraping thickness of a position on the wall tile and attached to the position increases and forms a protrusion to fill the recess. When a position on the wall is protruded, correspondingly, the glue scraping thickness of a position on the wall tile and attached to the position decreases and forms a recess so that glue is totally attached to the wall in completion of paving. In brief, for a protrusion position on the wall, glue on the wall tile and corresponding to the position is recessed. For a recess position on the wall, glue on the wall tile and corresponding to the position is protruded.

In an embodiment, as for the manner of acquiring the protrusion and recess information of the wall, the protrusion and recess information may be acquired by the first controller 101 processing the data shot by the depth camera. Additionally, the protrusion and recess information may also be acquired through an external device (for example, a measuring robot), then transmitted through a network to a controller in a wall tile paving robot, and transmitted by the controller to a first detection unit 100 in the wall tile paving robot. Alternatively, the first detection unit 100 is a part of the controller. The external device transmits the protrusion and recess information through the network to the first detection unit 100.

In an embodiment, as for the manner of acquiring the protrusion and recess information of the wall, wall protrusion and recess data measured by an external measuring device are transmitted to the first detection unit 100; alternatively, the protrusion and recess information may also be the information detected by the first detection unit 100 of a machine.

For example, a detection unit may be a product capable of implementing three-dimensional measurement and imaging technology, for example, a measuring robot existing in the market.

In an embodiment, the glue scraping assembly 200 includes a laser sensor and a first controller 101. The first controller 101 is electrically connected to the laser sensor. The first controller 101 is electrically connected to the glue scraping assembly 200. The laser sensor scans the wall and sends data acquired through scanning to the first controller 101. The first controller 101 processes the data scanned through the laser sensor so as to acquire the protrusion and recess information.

In this embodiment, the distance between the glue scraping assembly 200 and the wall tile is adjustable so as to adjust the glue scraping thickness. When the glue scraping assembly 200 is close to the wall tile, more glue is scraped, resulting in a relatively small glue thickness on the wall tile. When the glue scraping assembly 200 is away from the wall tile, less glue is scraped, resulting in a relatively large glue thickness on the wall tile.

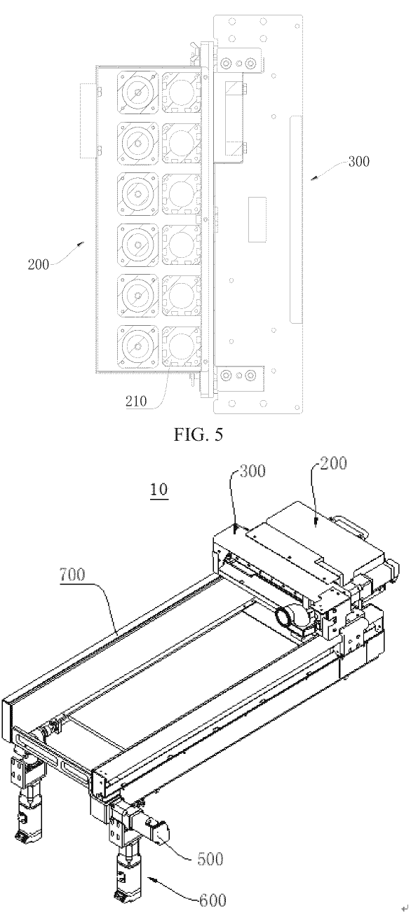

Referring to FIGS. 2 to 5, in this embodiment, the glue scraping assembly 200 includes a plurality of drive members 210 and a plurality of scrapers 220. The drive members 210 are in one-to-one correspondence to the scrapers 220. The drive members 210 are electrically connected to the first controller 101. The drive members 210 are used for driving the scrapers 220 to get close to or away from the wall tile. When the drive members 210 drive the scrapers 220 to get close to the wall tile, the glue scraping thickness decreases. When the drive members 210 drive the scrapers 220 to get away from the wall tile, the glue scraping thickness increases. When glue scraping is performed, according to the protrusion and recess information, the first controller 101 controls the drive members 210 to act so that the scrapers 220 get close to or away from the wall tile to modify the glue scraping thickness in a corresponding position. For example, when a protrusion exists on the wall, the first controller 101 controls the drive members 210 to act to make the scrapers 220 get close to the wall tile so that the glue scraping thickness matches the protrusion on the wall after glue scraping is performed. When a recess exists on the wall, the first controller 101 controls the drive members 210 to act to make the scrapers 220 get away from the wall tile so that the glue scraping thickness matches the recess on the wall after glue scraping is performed.

Referring to FIGS. 2 to 5, in this embodiment, the scrapers 220 are adjacent to each other and are disposed in a row in one direction. Correspondingly, the drive members 210 are disposed in a row in the same direction. The drive members 210 are linear drive members 210, for example, linear electric cylinders, linear air cylinders, and linear oil cylinders. In an embodiment, the drive members 210 are rotary drive members 210, for example, motors. The rotary drive members 210 can convert a rotational motion into a linear motion through a transmission mechanism and can adopt the rotational motion to adjust the distance between the scrapers 220 and the wall tile.

In some embodiments, the number of scrapers 220 may not correspond to the number of drive members 210. For example, the number of drive members 210 is greater than the number of scrapers 220. Multiple drive members 210 drive one scraper 220 to act simultaneously. In another example, the number of drive members 210 is smaller than the number of scrapers 220. One drive member drives multiple scrapers 220 to act simultaneously.

In an embodiment, the glue scraping assembly 200 includes a lifting structure and the scrapers 220. The wall tile is secured on the lifting structure. The scrapers 220 are located above the wall tile. When glue scraping is performed, the first controller 101 controls the drive members 210 to act so that the scrapers 220 get close to or away from the wall tile to modify the glue scraping thickness in a corresponding position. For example, when a protrusion exists on the wall, the first controller 101 controls the lifting structure to act to make the wall tile get close to the scrapers 220 so that the glue scraping thickness matches the protrusion on the wall after glue scraping is performed. When a recess exists on the wall, the first controller 101 controls the lifting structure to act to make the wall tile get away from the scrapers 220 so that the glue scraping thickness matches the recess on the wall after glue scraping is performed.

In this embodiment, before glue scraping is performed, glue with the maximum thickness satisfying the protrusion and recess information is spread on the wall tile first In this case, when glue scraping is performed, the first controller 101 controls the drive members 210 to extend and retract to complete glue scraping.

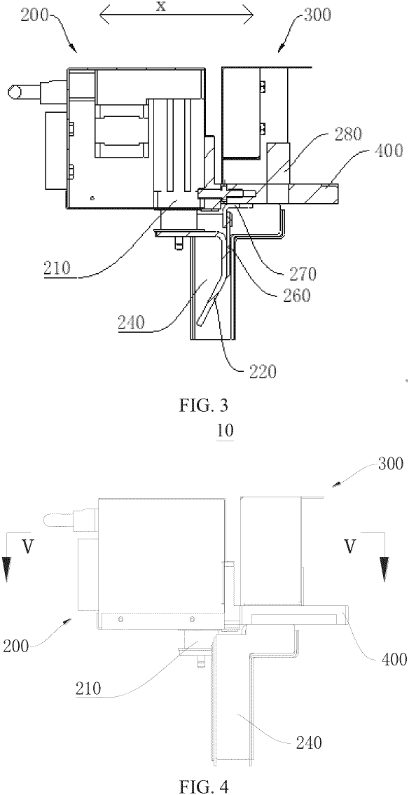

With reference to FIGS. 1 and 2 and in combination with FIG. 3, in this embodiment, the glue scraping mechanism 10 includes a glue spreading assembly 300. The glue spreading assembly 300 is electrically connected to the first detection unit 100. The glue spreading assembly 300 is able to spread glue on the wall tile according to the protrusion and recess information. The arrangement of the glue spreading mechanism enables the glue spreading mechanism to spread glue on the wall tile based on the protrusion and recess information. In this case, when glue scraping is performed, glue needing to be scraped is not much, which saves glue and is relatively environmentally friendly. For example, when the glue spreading assembly 300 spreads glue, the maximum thickness required for satisfying the protrusion and recess information, the minimum thickness required for satisfying the protrusion and recess information, or the average thickness required for satisfying the protrusion and recess information may be taken as glue spreading thickness so that spreading is performed. Alternatively, glue amount in each position may be adjusted according to the protrusion and recess information to implement accurate glue spreading.

With reference to FIGS. 1 and 2 and in combination with FIG. 3, in this embodiment, the glue scraping assembly 200 and the glue spreading assembly 300 are each connected to a second bracket 400 and are spaced apart in a width direction X of the second bracket 400. To enhance the stability of the structure, the glue scraping assembly 200 is connected to the glue spreading assembly 300 through a connection member. Referring to FIG. 3, in this embodiment, the glue scraping mechanism 10 includes a second detection unit 280. The second detection unit 280 is electrically connected to the glue spreading assembly 300. The second detection unit 280 is configured to detect the glue spreading thickness of the wall tile. The glue spreading assembly 300 is configured to be able to perform the glue supplement on the wall tile according to the protrusion and recess information and the glue spreading thickness in the glue scraping process. The arrangement in which the second detection unit 280 detects the glue spreading thickness provides a basis for whether the glue supplement is required, forming a negative feedback adjustment and guaranteeing the accurate and reliable glue scraping thickness.

In this embodiment, the second detection unit 280 is installed on the second bracket 400. The second detection unit 280 is located on one side where the glue spreading assembly 300 is located. The second detection unit 280 detects the glue thickness in a position where glue scraping is to be performed so that the glue spreading thickness is acquired. The first controller 101 is electrically connected to the second detection unit 280. The first controller 101 is electrically connected to the drive members 210. The first controller 101 is electrically connected to the glue spreading assembly 300. The second detection unit 280 transmits the acquired glue spreading thickness to the first controller 101. When the glue spreading thickness is unable to satisfy the glue scraping thickness determined according to the protrusion and recess information, the first controller 101 controls the glue spreading assembly 300 to spread glue so as to increase the glue thickness. When the glue spreading thickness is able to satisfy the glue scraping thickness determined according to the protrusion and recess information, the first controller 101 controls the drive members 210 to drive the scrapers 220 to scrape glue according to the glue scraping thickness determined according to the protrusion and recess information. After the first controller 101 processes the glue spreading thickness and the protrusion and recess information, the first controller 101 controls the glue spreading assembly 300 to supplement glue when the glue spreading thickness is unable to satisfy the requirement of the glue scraping thickness. When the glue spreading thickness is found to be able to satisfiy the requirement of the glue scraping thickness, the first controller 101 controls the drive members 210 to act and complete glue scraping.

When the glue spreading thickness is unable to satisfy the glue scraping thickness determined according to the protrusion and recess information, it indicates that the glue amount on the wall tile is insufficient and cannot match a protrusion or recess on the wall after glue scraping is performed. In this case, the first controller 101 controls the glue spreading assembly 300 to spread and supplement glue until the glue spreading thickness is able to satisfy the glue scraping thickness determined according to the protrusion and recess information. When the glue spreading thickness is able to satisfy the glue scraping thickness determined according to the protrusion and recess information, it indicates that glue on the wall tile is able to satisfy the requirement of the glue scraping thickness after glue scraping is performed. In this case, the first controller 101 controls the drive members 210 to drive the scrapers 220 to scrape glue based on the glue scraping thickness, guaranteeing that the protrusion and recess situation of glue on the wall tile matches the protrusion and recess situation of the wall.

In an embodiment, the second detection unit 280 is a laser distance sensor. The laser distance sensor detects a height (thickness) difference of the wall tile before and after glue spreading is performed, thereby acquiring the glue spreading thickness. The second detection unit 280 may also be, for example, a three-dimensional (3D) scanning device.

With reference to FIG. 2 and in combination with FIG. 3, in this embodiment, the glue scraping mechanism 10 includes a glue blocking plate 260. The glue blocking plate 260 is located on the rear side of the scrapers 220. For example, the glue blocking plate 260 is located between the scrapers 220 and the second detection unit 280. The glue blocking plate 260 fits against the scrapers 220. The glue blocking plate 260 is connected to the second bracket 400 through a connection plate 270. In the process of the scrapers 220 scraping glue, the glue may be accumulated on the scrapers 220. With the arrangement of the glue blocking plate 260, the accumulated glue is blocked when being in contact with the glue blocking plate 260. Under the action of the glue blocking plate 260, the accumulated glue falls back onto the wall tile, preventing an excessive glue accumulation from affecting the measurement of the glue spreading thickness performed by the second detection unit 280.

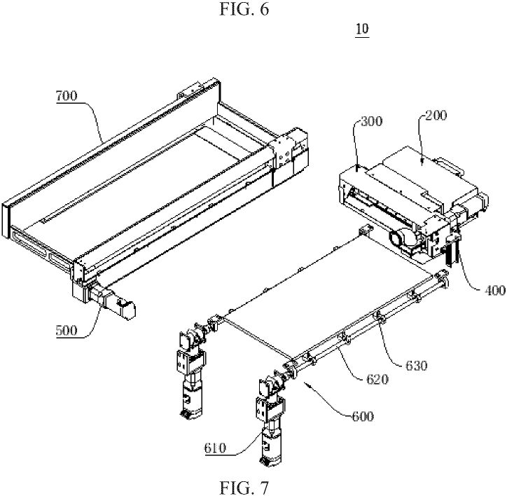

With reference to FIG. 6 and in combination with FIG. 7, in this embodiment, the glue scraping mechanism 10 includes a drive assembly 500 and a first bracket 700. The glue scraping assembly 200 and the glue spreading assembly 300 are slidably connected to the first bracket 700 through the second bracket 400. The drive assembly 500 is used for driving the glue scraping assembly 200 to reciprocate. The drive assembly 500 includes a first motor, a driving wheel, a driven wheel, and a transmission belt. The first motor is connected to the first bracket 700. An output end of the first motor is connected to the driving wheel. The driving wheel and the driven wheel may be rotatably connected to the first bracket 700 separately. The transmission belt connects the driving wheel with the driven wheel. The second bracket 400 is connected to the transmission belt. When the first motor rotates, the second bracket 400 is driven to slide relative to the first bracket 700, and the glue scraping assembly 200 and the glue spreading assembly 300 are driven to move.

With continued reference to FIGS. 2 and 3 and in combination with FIGS. 6 and 7, the glue scraping mechanism 10 includes a side glue scraping plate 240. The side glue scraping plate 240 is disposed on two sides of the glue scraping assembly 200. The side glue scraping plate 240 is connected to the second bracket 400 and is used for scraping glue on the first bracket 700. The glue scraping mechanism 10 further includes a chamfering plate 230. The chamfering plate 230 is connected to one side of the side glue scraping plate 240 facing away from the first bracket 700. When glue scraping is performed, the chamfering plate 230 chamfers glue.

In an embodiment, two side glue scraping plates 240 are arranged. The two side glue scraping plates 240 are disposed on two sides of the glue scraping assembly 200 separately.

Referring to FIG. 7, in this embodiment, the glue scraping mechanism 10 includes a wall tile clamp 600. The wall tile clamp 600 is located below the first bracket 700 and is used for clamping and securing the wall tile. The wall tile clamp 600 includes two groups of clamping assemblies. Each group of clamping assemblies includes a second motor 610, a rotary shaft 620, and a plurality of clamping clips 630. The second motor 610 is connected to the rotary shaft 620 by transmission. The clamping clips 630 are spaced apart in an axial direction of the rotary shaft 620. The two groups of clamping assemblies are space apart. When two second motors act, the clamping clips 630 are able to clamp and secure the wall tile.

Embodiments of the present application provide a glue scraping mechanism 10. The glue scraping mechanism 10 includes a first detection unit 100 and a glue scraping assembly 200. The first detection unit 100 is electrically connected to the glue scraping assembly 200. The first detection unit 100 is configured to acquire the protrusion and recess information of a wall. The glue scraping assembly 200 is configured to be able to adjust glue scraping thickness according to the protrusion and recess information. The glue scraping assembly 200 includes a plurality of drive members 210, and a plurality of scrapers 220 disposed side by side. The drive members 210 are in one-to-one correspondence to the scrapers 220. The drive members 210 are electrically connected to the first detection unit 100. The drive members 210 are used for driving the scrapers 220 to get close to or away from a wall tile to modify the glue scraping thickness. The glue scraping mechanism 10 includes a glue spreading assembly 300. The glue spreading assembly 300 is electrically connected to the first detection unit 100. The glue spreading assembly 300 is used for spreading glue on the wall tile. The glue spreading assembly 300 is configured to be able to perform a glue supplement on the wall tile according to the protrusion and recess information in a glue scraping process. The glue scraping mechanism 10 includes a second detection unit 280. The second detection unit 280 is electrically connected to the glue spreading assembly 300. The second detection unit 280 is configured to detect the glue spreading thickness of the wall tile. The glue spreading assembly 300 is configured to be able to perform the glue supplement on the wall tile according to the protrusion and recess information and the glue spreading thickness in the glue scraping process. The glue scraping mechanism 10 includes a glue blocking plate 260. The glue blocking plate 260 is located between the scrapers 220 and the second detection unit 280. The glue blocking plate 260 fits against the scrapers 220.

In an embodiment, the glue spreading assembly 300 includes components such as a glue cylinder for storing glue, a transmission mechanism, and a glue discharging mechanism.

Referring to FIG. 7, the glue scraping mechanism 10 provided in this embodiments works as below.

When the wall tile is secured under the first bracket 700 by the wall tile clamp 600, the drive assembly 500 starts to drag the glue spreading assembly 300 to move from one end away from the first motor to one end close to the first motor. The glue spreading assembly 300 performs preliminary spreading. When the glue spreading assembly 300 reaches one end close to the first motor, the drive assembly 500 starts to drag the glue spreading assembly 300 and the glue scraping assembly 200 to move from one end close to the first motor to one end away from the first motor. The glue scraping assembly 200 starts to scrape glue according to the protrusion and recess information. When the first controller 101 determines that the glue thickness before the scrapers 220 is sufficient, the glue spreading assembly 300 does not act. When the first controller 101 determines that the glue thickness before the scrapers 220 is insufficient, the glue spreading assembly 300 acts and starts to spread glue so as to increase the glue thickness. In a process where the glue spreading assembly 300 returns to an original position, the drive members 210 drive the scrapers 220 to scrape glue according to the protrusion and recess information. When the scrapers 220 cross an edge of the wall tile, glue scraping is completed. In the glue scraping process, the side glue scraping plate 240 automatically scrapes the glue inside the first bracket 700.

The glue scraping mechanism 10 acquires the protrusion and recess information of the wall through the first detection unit 100 and adjusts the glue scraping thickness of the wall tile according to the protrusion and recess information so that the wall tile is totally attached to the wall in completion of paving, guaranteeing a pasting effect and achieving a relatively low hollowing rate. The arrangement of the glue spreading assembly 300 helps supplement glue for the wall tile. When glue on the wall tile is unable to satisfy the requirement of the glue scraping thickness, the glue spreading assembly 300 may supplement glue. With the arrangement of the glue blocking plate 260, the accumulated glue is blocked when being in contact with the glue blocking plate 260. Under the action of the glue blocking plate 260, the accumulated glue falls back onto the wall tile, preventing an excessive glue accumulation from affecting the detection of the glue spreading thickness performed by the second detection unit 280.

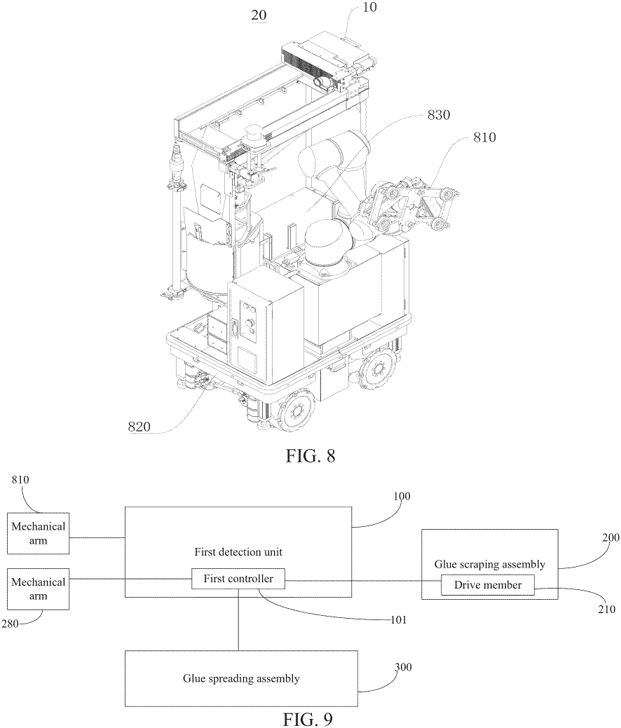

Referring to FIG. 8, this embodiment further provides a wall tile paving device 20. The wall tile paving device 20 includes a mechanical arm 810, a chassis 820, a tile laying assembly 830, and the preceding glue scraping mechanism 10. The glue scraping mechanism 10, the tile laying assembly 830, and the mechanical arm 810 are disposed on the chassis 820. A first detection unit 100 is connected to the mechanical arm 810. The wall tile paving device 20 can automatically pave a wall tile. Moreover, the paved wall tile is well attached to a wall through secure pasting and with good flatness.

In an embodiment, the tile laying assembly 830 is a platform for placing the wall tile. The platform may be provided with a baffle plate to limit the movement of the tile.

This embodiment further provides a wall tile paving method. The wall tile paving method includes extracting a point cloud of wall information, acquiring protrusion and recess information of a wall, converting the protrusion and recess information of the wall into glue thickness information, and spreading and scraping glue according to the glue thickness information. The wall tile paving method is used for scraping glue. The glue thickness on a wall tile matches the protrusion and recess situation of the wall. In the completion of paving, the wall tile is closely attached to the wall.

When the glue is spread and scraped according to the glue thickness information, the glue thickness on the wall tile is monitored in real time. In response to glue spreading thickness being unable to satisfy the glue thickness determined according to the protrusion and recess information, the glue spreading thickness is increased through a glue supplement. In response to the glue spreading thickness being able to satisfy the glue thickness determined according to the protrusion and recess information, redundant glue is scraped. It guarantees through the glue supplement operation that the glue thickness on the wall tile can satisfy the glue thickness determined according to the protrusion and recess information.

Embodiments of the present application provide a glue scraping mechanism with an aim of solving the problem that a wall tile is prone to be hollow or is pasted insecurely when a wall is rough and uneven in the related art.

In an embodiment, the glue scraping assembly includes a plurality of drive members, and a plurality of scrapers disposed side by side. The drive members correspond to the scrapers in a one-to-one manner. The drive members are electrically connected to the first detection unit 100. The drive members are used for driving the scrapers to get close to or away from the wall tile to modify glue scraping thickness. When the drive members drive the scrapers to get close to the wall tile, the glue thickness decreases. When the drive members drive the scrapers to get away from the wall tile, the glue thickness increases to implement the adjustment of the glue scraping thickness.

In an embodiment, the glue scraping mechanism includes a drive assembly and a first bracket. The glue scraping assembly is slidably connected to the first bracket. The drive assembly is configured to drive the glue scraping assembly to reciprocate. The arrangement of the drive assembly helps the drive assembly to reciprocate relative to the first bracket.

In an embodiment, the glue scraping mechanism includes a side glue scraping plate. The side glue scraping plate is disposed on two sides of the glue scraping assembly and is used for scraping glue on the first bracket. The arrangement of the side glue scraping plate prevents glue from being adhered to the first bracket.

What is claimed is:

1. A glue scraping mechanism, used for controlling a thickness of spread glue, wherein the glue scraping mechanism comprises a first detection unit and a glue scraping assembly, the first detection unit is electrically connected to the glue scraping assembly, the first detection unit is configured to acquire protrusion and recess information of a wall, and the glue scraping assembly is configured to be able to adjust a glue scraping thickness according to the protrusion and recess information.

2. The glue scraping mechanism according to claim 1, wherein a distance between the glue scraping assembly and a wall tile is adjustable so as to adjust the glue scraping thickness.

3. The glue scraping mechanism according to claim 1, wherein the glue scraping assembly comprises a plurality of drive members, and a plurality of scrapers disposed side by side, the plurality of drive members are in one-to-one correspondence to the plurality of scrapers, the plurality of drive members are electrically connected to the first detection unit, and the plurality of drive members are used for driving the plurality of scrapers to get close to or away from a wall tile.

4. The glue scraping mechanism according to claim 3, further comprising a glue blocking plate, wherein the glue blocking plate is located on one side of the plurality of scrapers, and the glue blocking plate fits against the plurality of scrapers.

5. The glue scraping mechanism according to claim 1, further comprising a drive assembly and a first bracket, wherein the glue scraping assembly is slidably connected to the first bracket, and the drive assembly is used for driving the glue scraping assembly to reciprocate.

6. The glue scraping mechanism according to claim 5, further comprising a side glue scraping plate, wherein the side glue scraping plate is disposed on one of two sides of the glue scraping assembly and is used for scraping glue on the first bracket.

7. The glue scraping mechanism according to claim 6, further comprising a chamfering plate, wherein the chamfering plate is connected to one side of the side glue scraping plate facing away from the first bracket.

8. The glue scraping mechanism according to claim 5, further comprising a wall tile clamp, wherein the wall tile clamp is located below the first bracket and is used for clamping and securing a wall tile.

9. The glue scraping mechanism according to claim 1, further comprising a glue spreading assembly, wherein the glue spreading assembly is electrically connected to the first detection unit, the glue spreading assembly is used for spreading glue on a wall tile, and the glue spreading assembly is configured to be able to perform a glue supplement on the wall tile according to the protrusion and recess information in a glue scraping process.

10. The glue scraping mechanism according to claim 9, further comprising a second detection unit, wherein the second detection unit is electrically connected to the glue spreading assembly, the second detection unit is configured to detect a glue spreading thickness of the wall tile, and the glue spreading assembly is configured to be able to perform the glue supplement on the wall tile according to the protrusion and recess information and the glue spreading thickness in the glue scraping process.

11. The glue scraping mechanism according to claim 10, wherein the first detection unit comprises a first controller: the first controller is electrically connected to the second detection unit; the first controller is electrically connected to the glue scraping assembly; the first controller is electrically connected to the glue spreading assembly; the second detection unit transmits an acquired glue spreading thickness to the first controller: the first controller is configured to, in response to the glue spreading thickness being unable to satisfy the glue scraping thickness determined according to the protrusion and recess information, control the glue spreading assembly to spread glue so as to increase glue thickness: and the first controller is configured to, in response to the glue spreading thickness being able to satisfy the glue scraping thickness determined according to the protrusion and recess information, control the glue scraping assembly to scrape glue according to the glue scraping thickness determined according to the protrusion and recess information.

12. A wall tile paving device, comprising a mechanical arm, a chassis, a tile laying assembly, and the glue scraping mechanism according to claim 1: wherein the glue scraping mechanism, the tile laying assembly, and the mechanical arm are disposed on the chassis: and a first detection unit is connected to the mechanical arm.

13. A wall tile paving method, comprising:
extracting a point cloud of wall information, acquiring protrusion and recess information of a wall, converting the protrusion and recess information of the wall into glue thickness information, and spreading and scraping glue according to the glue thickness information.

14. The wall tile paving method according to claim 13, further comprising:
monitoring a glue spreading thickness on a wall tile in real time when the glue is spread and scraped according to the glue thickness information: in response to the glue spreading thickness being unable to satisfy glue thickness determined according to the protrusion and recess information, increasing the glue spreading thickness through a glue supplement; and in response to the glue spreading thickness being able to satisfy the glue thickness determined according to the protrusion and recess information, scraping redundant glue.

15. The wall tile paving method according to claim 12, wherein a distance between the glue scraping assembly and a wall tile is adjustable so as to adjust the glue scraping thickness.

16. The wall tile paving method according to claim 12, wherein the glue scraping assembly comprises a plurality of drive members, and a plurality of scrapers disposed side by side, the plurality of drive members are in one-to-one correspondence to the plurality of scrapers, the plurality of drive members are electrically connected to the first detection unit, and the plurality of drive members are used for driving the plurality of scrapers to get close to or away from a wall tile.

17. The wall tile paving method according to claim 16,wherein the glue the scraping mechanism further comprises a glue blocking plate, wherein the glue blocking plate is located on one side of the plurality of scrapers, and the glue blocking plate fits against the plurality of scrapers.

18. The wall tile paving method according to claim 12, wherein the glue scraping mechanism further comprises a drive assembly and a first bracket, wherein the glue scraping assembly is slidably connected to the first bracket, and the drive assembly is used for driving the glue scraping assembly to reciprocate.

19. The wall tile paving method according to claim 18, wherein the glue scraping mechanism further comprises a side glue scraping plate, wherein the side glue scraping plate is disposed on one of two sides of the glue scraping assembly and is used for scraping glue on the first bracket.

20. The wall tile paving method according to claim 19, the glue scraping mechanism further comprises a chamfering plate, wherein the chamfering plate is connected to one side of the side glue scraping plate facing away from the first bracket.
